(19) United States
(12) Patent Application Publication
(10) Pub. No.: US 2007/0081927 A1
(43) Pub. Date: Apr. 12, 2007

(54) Catalytic converter cover

(76) Inventor: Woon-Suck Baek, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,087

(22) Filed: Dec. 12, 2005

(30) Foreign Application Priority Data
Oct. 7, 2005 (KR) 10-2005-0094272

(51) Int. Cl. B01D 50/00; B01D 53/34

(52) U.S. Cl. 422/179; 422/177

(57) ABSTRACT

The invention provides a catalytic converter cover which consists of an upper cover and a lower cover surrounding a catalytic converter. Each of the upper cover and the lower cover has an arc-shaped cross-section that extends a predetermined length in a flow direction of exhaust gas passing through the catalytic converter cover. Each of the upper cover and lower cover has a plurality of overlapping plates with different thicknesses.

### CROSS-REFERENCE TO RELATED APPLICATIONS

The present application claims priority to Korean Application Serial Number 10-2005-0094272, filed on Oct. 7, 2005, the disclosure of which is hereby incorporated by reference herein in its entirety.

### FIELD OF THE INVENTION

The present invention relates to catalytic converters. In particular, the invention relates to a device which isolates noise and vibrations generated in a catalytic converter in a vehicle.

### BACKGROUND OF THE INVENTION

There are millions of vehicle throughout the world and each vehicle is potentially a source of air pollution. In larger metropolitan areas, the amount of air pollution that all the vehicles produce collectively can be enormous. To combat this problem, federal, state, and local governments have enacted laws to curb the amount of air pollution vehicles may emit. To reduce the amount of pollution, automakers have developed a catalytic converter which serves to purify gas exhausted from a combustion chamber of an engine of a vehicle and consequently, remove air pollution. However, the catalytic converter has some drawbacks. The noise and vibration emitted from the catalytic converter sometimes makes a vehicle's ride uncomfortable for the driver and passengers. Therefore, the noise and vibration emitted from the catalytic converter should be appropriately isolated and absorbed to make a vehicle ride more comfortable.

### SUMMARY OF THE INVENTION

The present invention provides a catalytic converter cover, comprising an upper cover and a lower cover surrounding a catalytic converter in which each of the upper cover and the lower cover has an arc-shaped cross-section that extends a predetermined length in a flow direction of exhaust gas passing through the catalytic converter cover and each of the upper cover and the lower cover has a plurality of overlapping plates with different thicknesses.

In a preferred embodiment, the predetermined length of the covers is between 1 centimeter and 50 centimeters. In a more preferred embodiment, the predetermined length of the covers is about 25 centimeters. In another embodiment, the exhaust gas is selected from the group consisting of nitrogen, carbon dioxide, water vapor, carbon monoxide, nitrogen oxides, hydrocarbons, and volatile organic compounds. In another preferred embodiment, the upper cover and the lower cover face each other with a first end of the upper cover overlap with a first end of the lower cover and both ends are fastened to the catalytic converter at predetermined positions adjacent to one of an exhaust gas inlet or an exhaust gas outlet of the catalytic converter and a medial portion of a second end of each of the upper and lower covers is fastened to the catalytic converter at a predetermined position adjacent to a remaining one of the exhaust gas inlet or an exhaust gas outlet of the catalytic converter.

In a preferred embodiment, the upper cover and the lower cover each comprise an inner plate and an outer plate, wherein the outer plate is thicker than the inner plate. In another embodiment, the thickness of the outer plate is between 1 and 2 times the thickness of the inner plate. In a more preferred embodiment, the thickness of the outer plate is about 1.5 times the thickness of the inner plate. In another embodiment, the upper cover and the lower cover each comprise an inner plate and an outer plate, wherein the inner plate is thicker than the outer plate. In another embodiment, the thickness of the inner plate is between 1 and 2 times the thickness of the outer plate. In a more preferred embodiment, the thickness of the inner plate is about 1.5 times the thickness of the outer plate.

In another embodiment, a plurality of beads is formed on the inner and the outer plates wherein each bead extends a predetermined length in a circumferential direction of the catalytic converter. In a preferred embodiment, the beads are honeycomb beads. In another preferred embodiment, the beads are ceramic beads. In another embodiment, the predetermined length of the beads is between 1 millimeter and 5 millimeter. In a more preferred embodiment, the predetermined length of the beads is about 3 millimeter. In another embodiment, a plurality of cooling holes is formed through the inner and outer plates between the beads.

### BRIEF DESCRIPTION OF THE DRAWINGS

FIG. 1 is a perspective view showing a catalytic converter cover mounted to a catalytic converter.

FIG. 2 is a sectional perspective view taken along the II line of FIG. 1.

### DETAILED DESCRIPTION OF THE PREFERRED EMBODIMENTS

A catalytic converter removes pollutants from motor vehicle exhaust, either by oxidizing them into carbon dioxide and water or reducing them to nitrogen. The main emissions of a vehicle include nitrogen, carbon dioxide, and vapor gas. Other emissions include carbon monoxide, hydrocarbons, and volatile organic compounds which are considered extremely harmful. Sunlight breaks these harmful emissions down to form oxidants, which react with oxides of nitrogen to cause ground level ozone (O₃), a major component of smog. Another harmful emission is nitrogen oxide (NO and NO₂) which contributes to smog and acid rain.

There are three types of catalytic converter: oxidation catalyst, reduction catalyst, and the three-way catalytic converter which is a combination of the oxidation and reduction catalyst.

This three-way catalytic converter catalyst is typically a multi-component material, containing the precious metals platinum, rhodium, a smaller amount of palladium, ceria, gamma alumina and a whole host of other metal oxides. “Three-way” refers to the three regulated emissions it helps to reduce—carbon monoxide, volatile organic compounds and nitrogen oxide molecules. The three-way catalyst contains a ceramic monolith or corderite enclosing the metal oxide particles in parallel channels. The exhaust emissions are then forced through the monolith which in whole is encased in strong metallic cylinder. These monoliths on average have 64 channel openings per cm2 this allows for high flow rate and high efficiency because of higher surface area. The corderite is used because it can withstand high temperatures with in the exhaust, when the engine starts the exhaust heats up to several hundred degrees in a minute. The three-way catalyst is a much more efficient system than the above two catalytic converters as it does not require additional catalyst beds to ensure complete conversion and is much smaller.

The three-way catalytic converter uses two different types of catalysts, a reduction catalyst and an oxidation catalyst. Both types of catalysts consist of a ceramic structure coated with a metal catalyst, usually platinum, rhodium and/or palladium.

The reduction catalyst is the first stage of the catalytic converter. It uses platinum and rhodium to help reduce the nitrogen oxide emissions. When an NO or NO₂ molecule contacts the catalyst, the catalyst rips the nitrogen atom out of the molecule and holds on to it, freeing the oxygen in the form of O₂. The nitrogen atoms bond with other nitrogen atoms that are also stuck to the catalyst, forming N₂. For example:
2NO=>N₂+O₂ or 2NO₂=>N₂+2O₂

The oxidation catalyst is the second stage of the catalytic converter. It reduces the unburned hydrocarbons and carbon monoxide by oxidizing them over a platinum and palladium catalyst. This catalyst aids the reaction of the CO and hydrocarbons with the remaining oxygen in the exhaust gas. For example:
2CO+O₂=>2CO₂

Oxidation catalysts convert carbon monoxide (CO) and hydrocarbons (HC) to carbon dioxide (CO₂) and water, but have little effect on nitrogen oxides (NO and NO₂) and particulate matter.

The third stage is a control system that monitors the exhaust stream, and uses this information to control the fuel injection system. There is an oxygen sensor mounted upstream of the catalytic converter, meaning it is closer to the engine than the converter is. This sensor tells the engine computer how much oxygen is in the exhaust. The engine computer can increase or decrease the amount of oxygen in the exhaust by adjusting the air-to-fuel ratio. This control scheme allows the engine computer to make sure that the engine is running at close to the stoichiometric point, and also to make sure that there is enough oxygen in the exhaust to allow the oxidization catalyst to burn the unburned hydrocarbons and CO.

There are two main types of structures used in catalytic converters: honeycomb and ceramic beads. Typically, the inside of the catalytic converter is a honeycomb set of passageways or small ceramic beads coated with catalysts. There are many passages for the exhaust gases to flow, to allow for the maximum amount of surface area for the hot gases to pass. Most vehicles today use a honeycomb structure.

Hereinafter, an embodiment of the present invention will be described in detail with reference to the attached drawings.

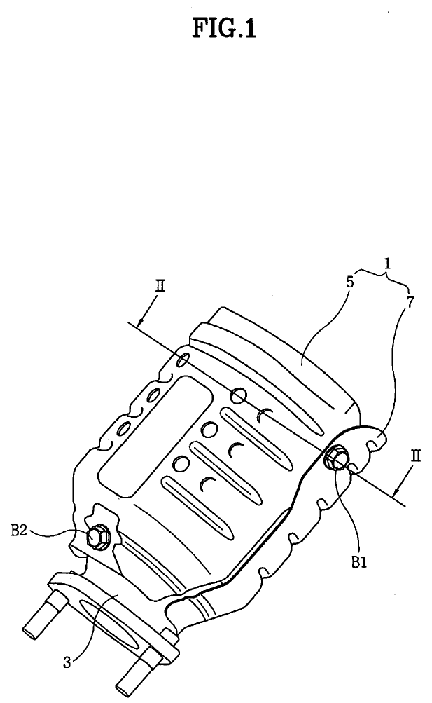

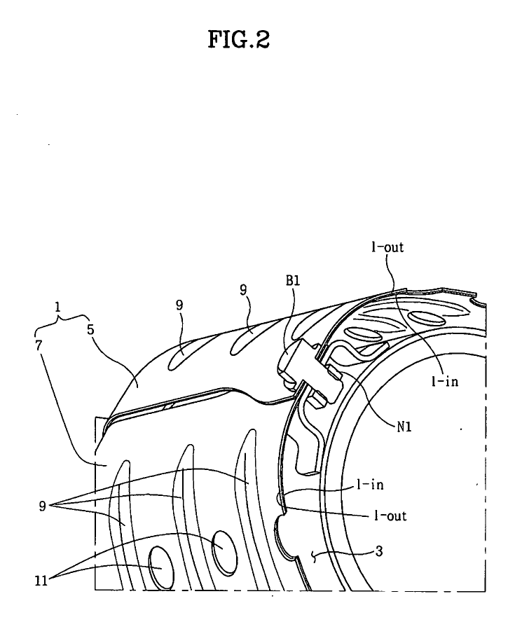

Referring to FIGS. 1 and 2, a catalytic converter cover 1 according to the embodiment of the present invention includes an upper cover 5 and a lower cover 7 which surround a catalytic converter 3. Each of the upper cover 5 and the lower cover 7 has an arc-shaped cross-section which extends a predetermined length in the direction in which exhaust gas passes through the catalytic converter 3. The catalytic converter cover may be between 1 and 50 centimeters, with 25 centimeters being most preferable.

The upper cover 5 and the lower cover 7 face each other around the catalytic converter 3. Both sides of first ends of the upper and lower covers 5 and 7 overlap each other and are fastened to the catalytic converter 3 at predetermined positions adjacent either to an exhaust gas inlet or to an exhaust gas outlet of the catalytic converter 3. A medial portion of a second end of each of the upper cover 5 and lower cover 7 is fastened to the catalytic converter 3 at a predetermined position adjacent to a remaining one of the exhaust gas inlet or an exhaust gas outlet of the catalytic converter 3.

The upper cover 5 and the lower cover 7 are coupled at both sides of the first ends thereof to the catalytic converter 3 by two pairs of bolts B1 and nuts N1, as shown in the drawings. For reference, only two bolts are shown in FIG. 1, and the remaining two bolts are provided at positions symmetrical to the respective bolts shown in FIG. 1.

The second end of each of the upper and lower covers 5 and 7 is coupled at the medial portion thereof to the catalytic converter 3 by a paired bolt B2 and a nut. As such, the upper and lower covers 5 are coupled to the catalytic converter 3 by a total of four pairs of bolts and nuts.

Each of the upper and lower covers 5 and 7 is manufactured by laminating two plates having different thicknesses as described in FIG. 2. In other words, each of the upper and lower covers 5 and 7 includes an outer plate 1-out which is thicker than the inner plate 1-in. In this particular embodiment, the outer plate 1-out has a thickness of 0.6 mm. whereas inner plate 1-in is 0.4 mm. in thickness. Therefore, outer plate 1-out is 1.5 times thicker than inner plate 1-in.

Alternatively, the inner plate 1-in may be thicker than the outer plate 1-out, or the inner plate 1-in and the outer plate 1-out may be made of different materials. Thereby, the characteristics between the inner and outer plates 1-in and 1-out must be different.

To manufacture each of the upper and lower covers 5 and 7 (hereinafter, the upper cover and lower cover is collectively called the “catalytic converter cover”), the inner plate 1-in and the outer plate 1-out are shaped by pressing two plates, which overlaps each other. Thereafter, the inner plate 1-in and the outer plate 1-out are bonded to each other by spot welding at several positions, thus completing the upper and lower cover manufacturing process.

Furthermore, the catalytic converter cover 1 includes a plurality of beads 9 which are formed on the surface of the catalytic converter cover 1 and extend a predetermined length in a circumferential direction of the catalytic converter 3. The beads 9 formed in the catalytic converter cover 1 increase the strength of the catalytic converter cover 1 and prevent vibrations and noise from being undesirably generated in areas. The predetermined length of the beads is between 1 millimeter and 5 millimeters.

A plurality of cooling holes 11 is formed between the beads 9. The cooling holes 11 allow air to flow therethrough so as to cool the catalytic converter 3. As well, the cooling holes 11 reduce the surface area of the catalytic converter cover 1 such that the amount of noise and vibration emitted from the catalytic converter cover 1 is as low as possible.

As is apparent from the foregoing, the present invention provides a catalytic converter cover which is manufactured by laminating an inner plate and an outer plate, which are different in thickness, thus efficiently isolating and absorbing noise and vibration emitted from a catalytic converter, thereby enhancing the NVH characteristics of a vehicle.

What is claimed is:

1. A catalytic converter cover, comprising:
an upper cover and a lower cover surrounding a catalytic converter
wherein
each of the upper cover and the lower cover has an arc-shaped cross-section that extends a predetermined length in a flow direction of exhaust gas passing through the catalytic converter cover; and
each of the upper cover and the lower cover has a plurality of overlapping plates with different thicknesses;
thereby forming a catalytic converter cover.

2. The catalytic converter cover according to claim 1, wherein said predetermined length is between 1 centimeter and 50 centimeters.

3. The catalytic converter cover according to claim 1, wherein said predetermined length is about 25 centimeters.

4. The catalytic converter cover according to claim 1, wherein said exhaust gas is selected from the group consisting of nitrogen, carbon dioxide, water vapor, carbon monoxide, nitrogen oxides, hydrocarbons, and volatile organic compounds.

5. The catalytic converter cover according to claim 1, wherein
the upper cover and the lower cover face each other;
a first end of the upper cover overlap with a first end of the lower cover and both ends are fastened to the catalytic converter at predetermined positions adjacent to one of an exhaust gas inlet or an exhaust gas outlet of the catalytic converter; and
a medial portion of a second end of each of the upper and lower covers is fastened to the catalytic converter at a predetermined position adjacent to a remaining one of the exhaust gas inlet or an exhaust gas outlet of the catalytic converter.

6. The catalytic converter cover according to claim 1, wherein said upper cover and lower cover each comprise an inner plate and an outer plate, wherein said outer plate is thicker than said inner plate.

7. The catalytic converter cover according to claim 6, wherein the thickness of the outer plate is between 1 and 2 times the thickness of the inner plate.

8. The catalytic converter cover according to claim 6, wherein the thickness of the outer plate is about 1.5 times the thickness of the inner plate.

9. The catalytic converter cover according to claim 1, wherein said upper cover and lower cover each comprise an inner plate and an outer plate, wherein said inner plate is thicker than said outer plate.

10. The catalytic converter cover according to claim 9, wherein the thickness of the inner plate is between 1 and 2 times the thickness of the outer plate.

11. The catalytic converter cover according to claim 9, wherein the thickness of the inner plate is about 1.5 times the thickness of the outer plate.

12. The catalytic converter cover according to claim 1, wherein each of the upper covers and the lower covers further comprises:
a plurality of beads formed on the inner and the outer plates wherein each bead extends a predetermined length in a circumferential direction of the catalytic converter.

13. The catalytic converter cover according to claim 12, wherein said beads are honeycomb beads.

14. The catalytic converter cover according to claim 12, wherein said beads are ceramic beads.

15. The catalytic converter cover according to claim 12, wherein said predetermined length of the beads is between 1 millimeter and 5 millimeter.

16. The catalytic converter cover according to claim 12, wherein said predetermined length of the beads is about 3 millimeter.

17. The catalytic converter cover according to claim 1, wherein each of the upper covers and the lower covers further comprises:
a plurality of cooling holes formed through the inner and outer plates between the beads.
